(19) United States
(12) Patent Application Publication
(10) Pub. No.: US 2003/0184894 A1
(43) Pub. Date: Oct. 2, 2003

(54) Transparent panel for a display device and mobile radio device provided with such a panel

(76) Inventors: Stefan Bischof, Nersingen (DE); Cornelia Schrack, Ulm (DE)

Correspondence Address: BELL, BOYD & LLOYD, LLC, P. O. BOX 1135, CHICAGO, IL, 60690-1135, US

(21) Appl. No.: 10/362,702

(22) PCT Filed: Aug. 14, 2001
(86) PCT No.: PCT/DE01/03111

(30) Foreign Application Priority Data
Aug. 25, 2000 (DE) 100 41 786.8

(51) Int. Cl. G02B 5/00

(52) U.S. Cl. 359/894; 359/609

(57) ABSTRACT

The invention relates to a transparent panel (TS) for a display device (DP), especially for a mobile radio device (CP). The back of said panel is provided with one or more three-dimensional elevations and/or indentations in such a way that they are readable on the front (VS) of the panel as symbols.

Electric and/or optical devices such as, for example, mobile radio devices, in particular cellular telephones (=“mobiles”) are usually printed on their housing surface in the region of their display device with graphic characters such as, for example, manufacturer's names, type designation, etc., logos, motifs or other symbols, and are therefore externally marked. In the practical use of, for example, mobile radio devices, their symbols thus printed on can, however, be entirely or partially rubbed off, scratched, soiled or have their original appearance impaired in some other way. In particular, such phenomena of wear and traces of use can excessively spoil the overall optical impression, that is to say the original design of the respective mobile radio device considered overall.

It is the object of the invention to indicate a way in which an identification with one or more symbols can be provided for a display device in a simple and reliable way. This object is achieved with the aid of the features of claim 1.

A largely permanent identification is ensured owing to the fact that one or more symbols are provided on the rear side of transparent panel for the display device by means of one or more three-dimensional elevations and/or depressions. Since the symbols are located on the rear side of the transparent panel, they are prevented from being worn, soiled, scratched or otherwise impaired. Moreover, this way of providing the symbols saves space, and this is advantageous particularly in the case of mobile radio devices, particularly mobile cellular telephones. The point is that there is no longer any need to print the housing in order to identify, for example, the respective mobile radio device. Furthermore, the one or more symbols in the form of one or more three-dimensional elevations and/or depressions on the rear side of the transparent panel convey to the viewer on the viewing side, that is to say front side of the transparent panel, an optically appealing, three-dimensional effect that additionally improves the design.

The invention further relates to a mobile radio device having a display device that is covered by at least one panel according to the invention.

Other developments of the inventions are reproduced in the subclaims.

The invention and its developments are explained in more detail below with the aid of drawings, in which:

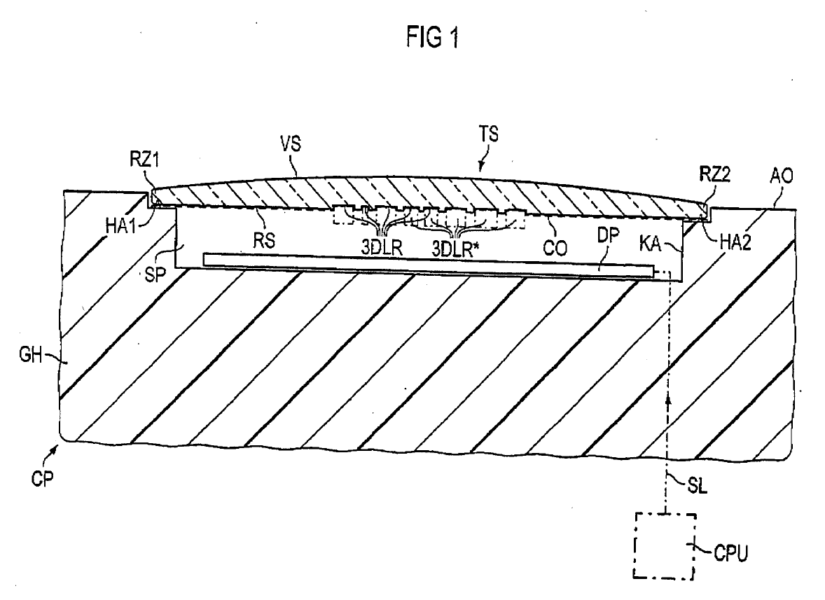

FIG. 1 shows a cross-sectional schematic of the display device of a mobile radio device having a first exemplary embodiment of a transparent panel according to the invention, and

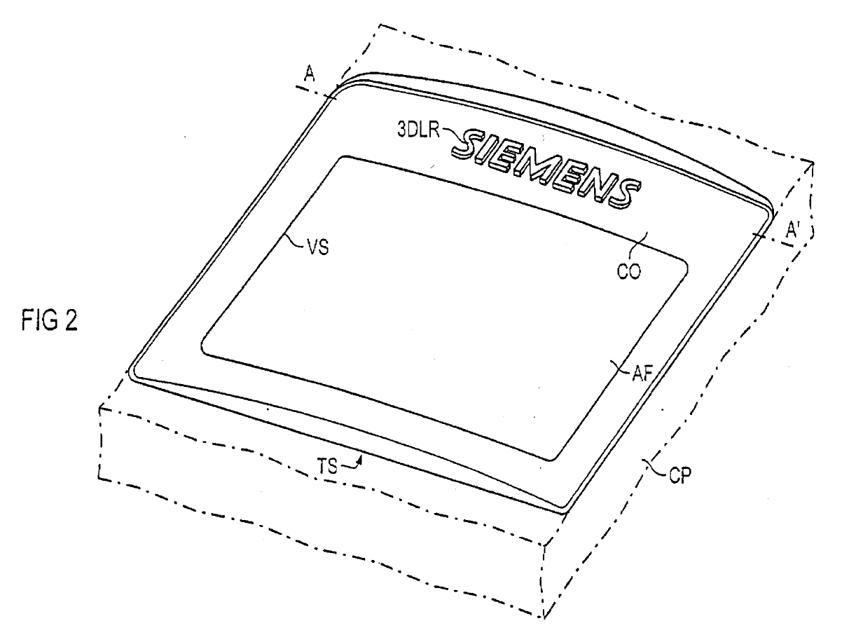

FIG. 2 shows a perspective schematic of the panel of FIG. 1 from the front, that is to say viewed from its viewing side.

### Elements having the same function and mode of operation are provided with the same reference symbols in FIGS. 1 and 2.

FIG. 1 shows an enlarged cross-sectional schematic of an exemplary embodiment of a transparent panel according to the invention for the display device DP of a mobile radio device CP, in particular a mobile cellular telephone. The transparent panel is denoted by TS in this case. The latter is viewed in FIG. 2 schematically and in an enlarged fashion substantially in plan view from the front, that is to say illustrated from its viewing side. The cross sectional image of FIG. 1 results in this case from viewing perpendicular to the positioning plane of the panel TS of FIG. 2 along the line of section A, A′ that is drawn in with dots and dashes in FIG. 2, and runs transversely, in particular, perpendicular to the longitudinal extent of the mobile radio device CP. The contours of the housing of the mobile radio device CP are also indicated in this case in FIG. 2 in a detail additionally provided with dots and dashes. The control/computing unit CPU of the mobile radio device CP is also drawn in with dots and dashes in FIG. 1. It controls the display device DP via a data line SL that is likewise drawn in with dots and dashes.

In FIG. 1, the transparent panel TS is seated as a type of cover in the region of the outer surface of the housing GH. In this case, it covers a chamber or cutout KA in the interior of the housing GH from the outside. A display device DP is accommodated in this chamber KA. It is preferred to select as display device a so-called liquid crystal display (LCD display) such as is normally used for mobile radio devices, in particular mobiles. The transparent panel TS is assigned in this case to the display device DP in such a way that, when viewed inward from the outside it is seated in the housing GH in front of the display device DP and covers the latter from the outside. Viewed relative to one another, the panel TS and the display DP are expediently positioned in such a way that the display field AF (compare FIG. 2) of the display device DP situated below it in the housing GH is visible to a viewer from the outside, that is to say remains visually readable. With its inside, the panel TS rests at its edge zones RZ1, RZ2 on correspondingly constructed shoulders HA1, HA2 of the housing GH and is fixed there mechanically. This mechanical fixing can be performed, for example, with the aid of an adhesive. It can equally be expedient for the panel TS to be fixed in the housing by means of mechanical latching or a self-closed fit or in some other way. In FIG. 1, the shoulders HA1, HA2 for bearing the edge zones RZ1, RZ2 of the panel TS are sunk by comparison with the remaining outer surface AO of the housing GH into the interior thereof. By comparison with the otherwise largely plane outer surface AO of the housing GH, the shoulders or bearing projections HA1, HA2 are expediently formed into the interior of the housing GH in a fashion depressed with reference to the otherwise largely plane outer surface AO of said housing GH in such a way that after it has been fitted into the housing GH the planel BL forms a largely flat plane with its remaining outer surface. Expressed in other words, this means that the panel TS is preferably fitted into the housing GH in such a way that its outer contour forms an approximately flush straight line with the outer contour AO of the housing GH when viewed in cross section. For this purpose the panel TS is preferably of substantially rectangular construction when viewed in cross section. If appropriate, as in the case of the exemplary embodiment according to FIG. 1, when viewed from the inside toward the outside, it can also have an outer surface cambered outwards in a slightly concave fashion.

In the exemplary embodiment of FIG. 1, the height of the shoulders or bearing projections HA1, HA2 is selected with reference to the base of the chamber KA in the housing GH in such a way that a free space or gap SP remains between the display device DP and the inner side RS of the panel TS. It is thereby advantageously possible for panels of different thickness and/or displays dimensioned with different thicknesses to be acceptably inserted into the chamber KA of the housing GH.

It is expedient to select a transparent plastic, in particular Plexiglas, for the transparent panel TS. In this way, the panel TS seals off the chamber KA with the internal display device DP from the outside in a largely hermetic fashion. The interior of the housing GH is therefore largely protected against external mechanical stresses, moisture, dust, dirt and other external environmental influences. At the same time, on the basis of its optical transparency the panel ensures that the display field of the display device DP remains visible and therefore readable to a user.

In FIG. 1, the edge zone region of the panel TS is coated with at least one colored layer CO from its inner side, that is to say rear side RS. In the present exemplary embodiment, the panel TS is of approximately rectangular construction in accordance with FIG. 2 when seen in plan view. The edge coating CO covers the panel BL on its rear side RS facing the chamber KA in such a way that a substantially rectangular display window AF results that remains free from the coating CO and is optically transparent. Thus, the actual display device DP remains visible from outside to an operator through this display window AF. In this case, the coating CO surrounds the display window AF of the panel TS along the four sides thereof as a substantially rectangular frame or edge. The coating CO is expediently formed by at least one colored layer in such a way that the panel TS is rendered substantially more opaque optically at its four outer edges, that is to say less transparent to light than in the display field AF. The result is that the display field AF of the display device DP is more neatly mounted. The frame-shaped mount of the display field AF is preferably constructed by the rear coating CO of the panel TS in such a way that only the display field of the display device DP is visible to the viewer from outside, whereas other components, accommodated in the housing GH, of the mobile radio device CP remain largely invisible to the viewer when viewed from outside. The edge width of the rear coating CO of the panel TS is expediently designed in such a way that at least the bearing projections HA1, HA2 are covered when viewed from outside. As a result, for example, adhesive with the aid of which the panel TS is fixed on the holders or projections HA1, HA2 is visually subdued or not visible at all from outside. Consequently, the internal coating CO provides a substantially rectangular framing of the panel TS that exposes a substantially rectangular, transparent viewing window onto the internal display DP for the viewer when viewed from outside.

The internal coating CO can preferably be produced by deposition, painting, by metallization, spraying or by printing in some other way. It is preferable for at least one colored layer to be applied for the rear coating. Bright colored, in particular silver colored pigments are preferably used for the colored layer. The coating the rear side RS of the panel TS with at least one colored layer can be carried out, in particular, with the aid of the so-called IMD (in mold decoration) method. In this case, there is laid in the mold as early as during the production of the panel TS a color-coated foil starting from which the color pigments are transferred onto the panel material by being pressed in whilst still in the hot state, and are fixed there.

In order now to identify the mobile radio device CP such as, for example, to render it distinguishable from the mobile radio devices of other manufacturers, and/or to give it a unique design, one or more three-dimensional depressions 3DLR are shaped in or recessed (viewed from inside outward) on the rear side RS of the panel TS in the direction of the outer surface, that is to say front side VS of the panel TS as one or more symbols. These depressions 3DLR are preferably provided in this case in the region of at least one of the edge zones of the panel TS. They are preferably situated inside the coated zone CO. In the present exemplary embodiment, the depressions 3DLR are embossed or shaped into the rear surface of the panel TS in such a way that the lettering “Siemens” results in accordance with FIG. 2 when viewed from the front side VS. Thus, if in general terms letters are selected as symbols, it is expedient for them to be introduced in a mirror-inverted fashion into the rear side RS of the panel TS such that they can be read as lettering from outside by a viewer on the viewing side or front side VS of the panel TS. Because one or more symbols are shaped into the rear surface RS of the panel TS by one or more three-dimensional depressions 3DLR, wear, scratching, soiling or any other mechanical, chemical and/or thermal impairment of this identification are advantageously largely avoided. In particular, in the case of mobile radio devices, preferably mobiles or mobile cellular telephones, that are held in the hand, the possibility of partial or complete detachment of the identifiers because of the sweat from a hand is largely avoided. Since the outer surface, that is to say the front side VS of the panel TS is largely of smooth design, deposits of dirt such as could occur, for example, in the depressions of a front-side, three-dimensional symbol or identifier, are largely avoided. Because the symbols are formed by three-dimensional depressions, owing to the shading effect of the edges of the depressions 3DLR there is the additional advantage that when viewed from the front side VS the character image is also additionally configured or designed appealingly in optical terms. Besides, owing to the largely smooth surface VS and the depth effect from the rear depressions 3DLR, the formation of shadows in the edges of the depressions 3DLR has a better effect, than three-dimensional depressions or elevations on the front side.

It is thereby possible with the aid of one or more three-dimensional depressions of appropriate shape to provide on the inner surface RS, facing the display device DP, of the panel TS symbols or characters that are largely resistant to wear and protected against external influences such as dirt, moisture, sweats on a hand, etc. Moreover, it is possible in conjunction with viewing from the front side VS simultaneously to achieve a three-dimensional effect of the symbols that is optically appealing with regard to the design. With the aid of the depressions 3DLR on the rear side RS of the panel TS, in addition or independently of letter characters, it is also possible, if appropriate, to image one or more logos, motifs or other identifiers.

If appropriate, it can also be expedient in addition or independently of depressions such as 3DLR on the rear side RS of the panel TS, for example, to provide one or more elevations there. Such elevations, which project inward into the chamber interior from the inner side RS of the panel TS in the direction of the display device DP, are drawn in additionally with dots and dashes in FIG. 1 and provided with the reference symbol 3DLR*. An appropriate three-dimensional effect of symbols when viewed from the front side VS can also be achieved by means of such elevations projecting inward toward the chamber KA. Since these three-dimensional elevations are located on the inner side of the panel TS, this identification is largely permanently maintained. Scratches, wear, soiling or other forms of impairment by external environmental influences are therefore largely avoided.

In addition to the particularly preferred use in the case of display devices of user terminals in cellular mobile radio systems such as, for example, those using the GSM or UMTS standard, the transparent panel according to the invention can also advantageously be used in other electrical and/or optical equipment having visual display devices.

1. A transparent panel (TS) for a display device (DP), one or more symbols being provided on the rear side (RS) of the panel by means of one or more three-dimensional elevations (3DLR*) and/or depressions (3DLR) in such a way that the symbols are readable on the front side (VS) of the panel.

2. The transparent panel characterized by the use as a display panel of a mobile radio device, in particular a mobile radio telephone.

3. The transparent panel as claimed in one of the preceding claims, characterized in that the display device is formed by an LCD display (DP).

4. The transparent panel as claimed in one of the preceding claims, characterized in that the three-dimensional elevations and/or depressions (3DLR*, 3DLR) are provided inside that subregion of the rear side (RS) that is situated outside the exposed display window (AF) of the panel.

5. The transparent panel as claimed in one of the preceding claims, characterized in that the three-dimensional elevations and/or depressions (3DLR*, 3DLR) are provided in that subregion of the rear side (RS) that is coated with at least one color layer (CO).

6. The transparent panel as claimed in one of the preceding claims, characterized in that the front side (VS) of the panel has a substantially plane surface.

7. The transparent panel as claimed in one of the preceding claims, characterized in that an optically transparent plastic material, in particular Plexiglas, is used for the panel.

8. The transparent panel as claimed in one of the preceding claims, characterized in that the three-dimensional elevations and/or depressions are introduced into the rear side (RS) in such a way that they form letters that are arranged in a mirror-inverted fashion and produce lettering that can be read from the front side (VS).

9. The transparent panel as claimed in one of the preceding claims, characterized in that at least one logo and/or other character is selected as symbol.

10. A mobile radio device (CP) having a display device DP that is covered by at least one transparent panel (TS) as claimed in one of the preceding claims.

11. The mobile radio device as claimed in claim 10, characterized in that the panel (TS) has at least one coating (CO) on its rear side (RS) along at least one subsection of its edge region, and in that the one or more three-dimensional elevations and/or depressions (3DLR*, 3DLR) are situated in this edge region.
